(19) United States
(12) Patent Application Publication
(10) Pub. No.: US 2013/0268409 A1
(43) Pub. Date: Oct. 10, 2013

(54) Network-Based Platform For Storing, Tracking, Sharing And Selection Of Consumer-Defined Preferences

(71) Applicant: MYPREF DIGITAL SERVICES PRIVATE LIMITED, Indore (IN)

(72) Inventor: Abhishek Chhajlani, Indore (IN)

(73) Assignee: MyPref Digital Services Private Limited, Indore (IN)

(21) Appl. No.: 13/850,547

(22) Filed: Mar. 26, 2013

Related U.S. Application Data
(60) Provisional application No. 61/621,490, filed on Apr. 7, 2012.

(51) Int. Cl. G06Q 50/00

(52) U.S. Cl. CPC G06Q 50/01; G06Q 30/0601
USPC 705/26.62; 705/26.1

(57) ABSTRACT

A system and method of enabling user-defined, preference-based retail shopping configured to be directed “outward” from the user—who defines his/her own “preferences” and then utilizes a network-connected mobile device to seek out “bricks and mortar” establishments where these “preferred” products/services may be found. Thus, instead of focusing on ways a merchant can reach “targeted” consumers, this system and method empowers the end-user/consumer to define his/her own preferences and make this information known to the retailers. A user develops a set of product/service “preferences” that are entered, updated, etc. to a network service platform via his/her mobile device. A user may make a recommendation about a product or service to someone in his “retail network”, where this is defined as referral or “ref” (and may also receive “refs” from other network members).

### CROSS REFERENCE TO RELATED APPLICATIONS

This application claims the benefit of U.S. Provisional Application Ser. No. 61/621,490, filed Apr. 7, 2012 and herein incorporated by reference.

### TECHNICAL FIELD

The present invention relates to a methodology for enabling a consumer to define preferences for specific goods and services via a mobile device, maintaining a database of these preferences and utilizing these preferences to enhance the consumer's “bricks and mortar” shopping experience.

### BACKGROUND OF THE INVENTION

The Internet has redefined how consumers and businesses interact with each other, providing instant access for consumers to online purchasing, and creating a unique marketing and distribution channel for businesses to reach their audiences. Businesses have been able to increase the effectiveness of targeting customers through the web; however, the art and science of reaching target audiences online is still very much in development.

Electronic commerce (e-commerce) has empowered consumers with the ability to obtain information on anything for sale online, at any time, from hundreds of millions of contributors around the world. Existing recommendation systems in online e-commerce portals allow users to research and create recommendations on items and services for sale, restaurants, vacation destinations, and so forth. Many of these systems allow for open access; in other words, anyone, anywhere can create content (i.e., a “recommendation”). Systems for providing recommendations based on relationships to an individual searching for information online have not yet evolved to a mature state. At most, recommendations may take into account relationships that interested parties have with items similarly bought or browsed by other consumers.

And yet, even with the advent of online retailing, many individuals desire to maintain the actual experience of shopping in a “bricks and mortar” store (i.e., an actual physical retail location). The integration of electronic information with a bricks and mortar experience is relatively new, and remains primarily a tool used by the retailers to “push” advertisements to all mobile-equipped shoppers in their store without any type of target advertising.

Another type of application on the Internet that has recently grown in popularity is the social network. Social networks allow individuals to connect with others through a mapping of relationships, whether they are representations of personal friendships, business relationships, common interests, or other relationships. Social networks have attempted to incorporate e-commerce functionality through targeted and non-targeted advertising systems, but these technologies have not yet developed to their full potential. Social networks are rich in relationship information, but have yet to harness it to empower businesses to connect with individuals, and vice versa.

### SUMMARY OF THE INVENTION

The needs remaining in the prior art are addressed by the present invention, which relates to a methodology for enabling a consumer to indicate preferences for types of products and services via a mobile device, maintaining a database of these preferences and utilizing them to enhance a “bricks and mortar” shopping experience.

In accordance with the present invention, the merging of online shopping, target advertising and social networking is re-configured to be directed “outward” from the user—who defines his/her own “preferences” and then utilizes a network-connected mobile device to seek out “bricks and mortar” establishments where these “preferred” products/services may be found. That is, instead of focusing on ways a merchant can reach “targeted” consumers, the present invention empowers the end-user/consumer (hereinafter referred to as “user”) to define his/her own preferences and make this information known to the retailers.

In at least one aspect of the present invention, a user is able to develop a set of product/service “preferences” that are entered, updated, etc. to a network service platform via his/her mobile device. In another aspect of the present invention, a user may make a recommendation about a product or service to someone in his “retail network”, where this is defined as referral or “ref” (and may also receive “refs” from other network members).

Indeed, one aspect of the present invention is the ability to determine the possibility of a particular product being of interest to a consumer based upon an analysis of the “preferences” of his/her friends, including as a factor any prior history of the consumer's preferences aligning with those of his/her friends.

In one aspect, the present invention discloses a network-based platform configured to enable user-defined, preference-based retail shopping, the platform including: a registered user database, the user database including a separate record for each user, the record including a listing of product/service preferences created and maintained by the registered user; a registered merchant database, the merchant database including a separate record for each merchant that has subscribed to preference-based retail shopping service, including a link for communicating with an external database maintained by the registered merchant; and a special-purpose computer in communication with the user database and the merchant database, the special-purpose computer including a microprocessor, memory and peripheral devices for analyzing, correlating and transmitting information regarding user preferences and merchant products and services, the special-purpose computer configured to interact via a communication network with mobile devices associated with each registered user, accepting modifications to the listings of preferences as transmitted by the users to the platform.

In another aspect, the present invention takes the form of a method of performing user-defined preference-based retail shopping comprising the steps of: creating a database of user-defined product/service preferences, the database capable of being updated by registered users via associated mobile devices; creating a database of registered merchants having retail locations in various cities, the database including a link for enabling communication with a merchant database; receiving, at a special-purpose computer at a network platform, a request from a registered user for finding a pre-defined preference/product service; determining, at the special-purpose computer, the current location of the registered user; utilizing a processor within the special-purpose computer to search the registered merchant database based upon the requested preference/product and current location of the registered user; and communicating the search results to the registered user to enable the registered user to review all results and continue with a retail purchase for a selected merchant.

Other and further aspects and features of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 illustrates an exemplary communication network within which the preference-based retail activities may be controlled;

FIG. 2 is a screenshot of the website associated with the preference-based shopping service of the present invention;

FIG. 3 is an exemplary record of user preferences (“prefs”) as stored within a registered user database of the inventive preference-based shopping service of the present invention, the user database located at the network-based preference service platform;

FIG. 4 is an exemplary of record of a registered merchant that utilizes the preference-based shopping service of the present invention;

FIG. 5 is a screen shot of a set of “prefs” as presented to a user, where these “prefs” have been previously defined by this user and entered into his database record at the preferences service platform;

FIG. 6 is a screen shot of various options associated with purchasing a specific “pref”;

FIG. 7 is a screen shot of a map showing locations where a specified “pref” may be purchased;

FIG. 8 is a screen shot of a particular merchant's other product offerings, indicating other ones of the user's “prefs” (as well as “refs”) that may be found at this location;

FIG. 9 is a screen shot of a set of “refs” that have been sent to a user; and

FIG. 10 is a diagram illustrating a method of determining a compatibility score for a set of “refs” that have been sent to a user.

### DETAILED DESCRIPTION

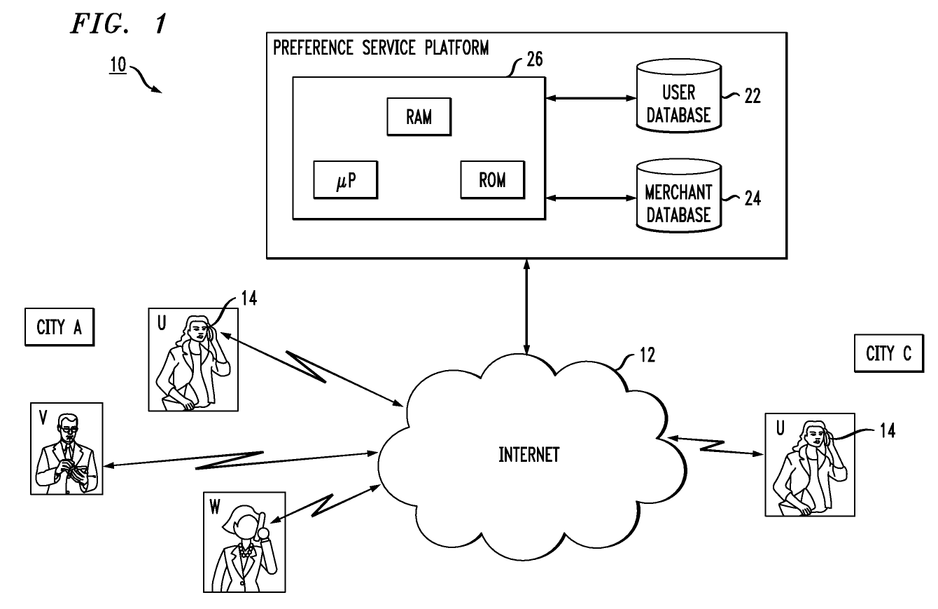

FIG. 1 illustrates an exemplary communication network 10 within which a user-defined, preference-based retail shopping experience may occur. As shown, network 10 includes a preference service platform 20 that interacts with various registered users and registered businesses through a communication network, represented in this instance as Internet 12. In order for individuals to avail themselves of the advantages of preference-based shopping in accordance with the present invention, it is necessary to use a communication device with geo-locating capabilities, such as available with various types of smartphones, tablets and the like (hereinafter collectively referred to as “mobile devices”). For the purposes of illustration, an exemplary user U is shown as having a mobile device 14 in his possession for performing preference-based shopping (among the myriad other uses for a mobile device).

As shown in FIG. 1, preference service platform 20 contains a database 22 of registered users (hereinafter referred to as “user database 22”), where the individual entries for each registered user are created, edited, updated and the like by the user himself. Similarly, preference service platform 20 contains a database 24 of registered merchants (hereinafter referred to as “merchant database 24”). As will be discussed in detail below, each registered merchant maintains a database listing of available products and services for each geographic location where the merchant is doing business (that is, each “bricks and mortar” location). Other types of associated information (e.g., sales, user-specific coupons and “specials”) may also be held within a registered merchant's database entry.

An individual that would like to become a “user” of preference-based shopping initiates the process by downloading the necessary software application onto his mobile device from a special-purpose computer 26 at preference service platform 20 (in this case, user U downloads a software application referred to as “myPref” onto mobile device 14). Special-purpose computer 26, as described in detail below, includes a processor, memory and peripheral devices that enable preference service platform 20 to perform analysis of various user preferences and merchant offerings, performing correlations and other types of data analysis regarding the retail activities of various users inter-connected within their own “retail network” (as a type of social networking function). By downloading this application, user U is establishing his account on preference service platform 20, creating a record in user database 22 for storing all of his product and service preferences.

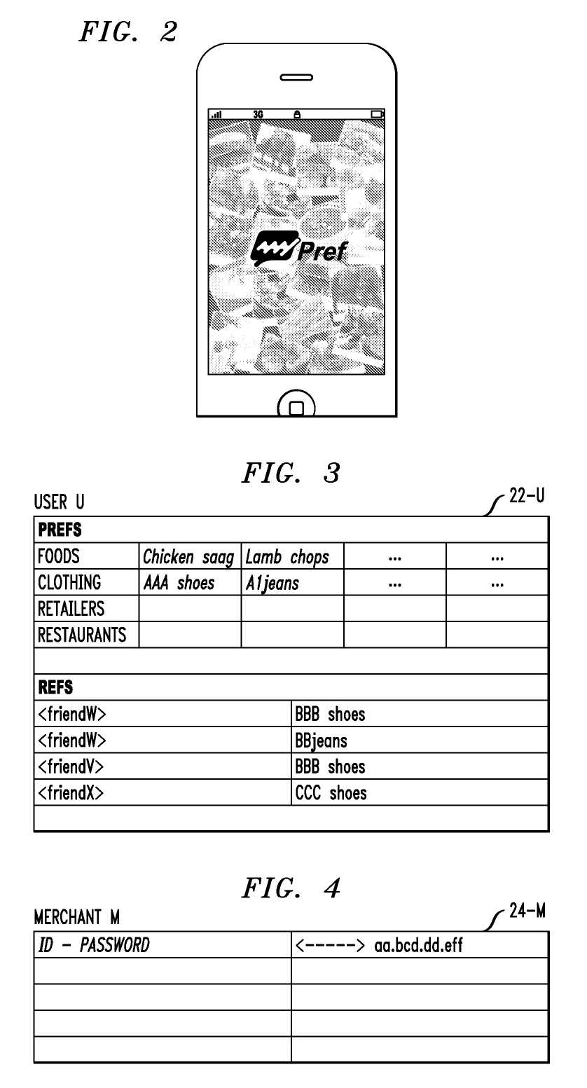

A screenshot of an exemplary myPref homepage as appearing on mobile device 14 is shown in FIG. 2. User U can then interact with this application and begin to populate his database record 22-U within user database 22 with his specific preferences. FIG. 3 shows an exemplary configuration for database record 22-U associated with user U and maintained within user database 22 at preference service platform 20. As will be discussed in detail below, user U may update, change, etc. the various “prefs” that he stores in his database record 22-U. It is a significant aspect of the present invention that all of these activities are controlled by the user himself, essentially “advertising” his preferences. This is considered to be a significant difference from various prior art types of targeted advertising where the merchant was in control of the products/services that were viewed by a user.

FIG. 4 shows an exemplary database record 24-M for a registered merchant that is offering his products at various retail establishments across the country. The database record for merchant M includes, in this case, information that can be used by special purpose computer 26 to launch a query to merchant M's (private) database system and retrieve the necessary information. It is to be understood that a merchant must first elect to participate in the “preference”-based service of the present invention, creating a record in merchant database 24. Indeed, the burden remains with the merchant to maintain updated and accurate information in this database record. Additionally, there may be other configurations that are used to retrieve merchant-specific information, the communication between special purpose computer 26 and the merchant's database system is considered as only one exemplary arrangement.

A social networking aspect to the user-defined preference shopping of the present invention is that the user is able to create a “retail network” with his friends and acquaintances—sharing his “prefs” with them (these being defined as referrals or “refs” on his friends' mobile devices (listing “U” as the person who sent the “ref”). For example, presume that user U has just purchased a new pair of running shoes (AAShoes) from AAClothes in his hometown (city A) and has found them to be exceptionally better than all of the shoes he has previously tried. He may now list “AAShoes” as a “pref” within his database record 22-U. Since he is a member of a running club with persons V and W (who are also members of his user-defined preference-based retail network), he thinks both of them would also like this type of running shoe. Thus, he sends a “ref” of “AAShoes” to both V and W, where this “ref” will now be contained in their database records 22-V and 22-W, respectively. Indeed, each database record maintains a listing of all products/services that a specific user lists as his/her “prefs”, as well as a separate listing of “refs”—where the listing of “refs” also includes the identity of the person in the retail network that sent the “ref”.

With this basic understanding, an exemplary method of employing a user-defined preference to make a purchase will now be explained detail, based on the diagrams as shown in FIGS. 1-4.

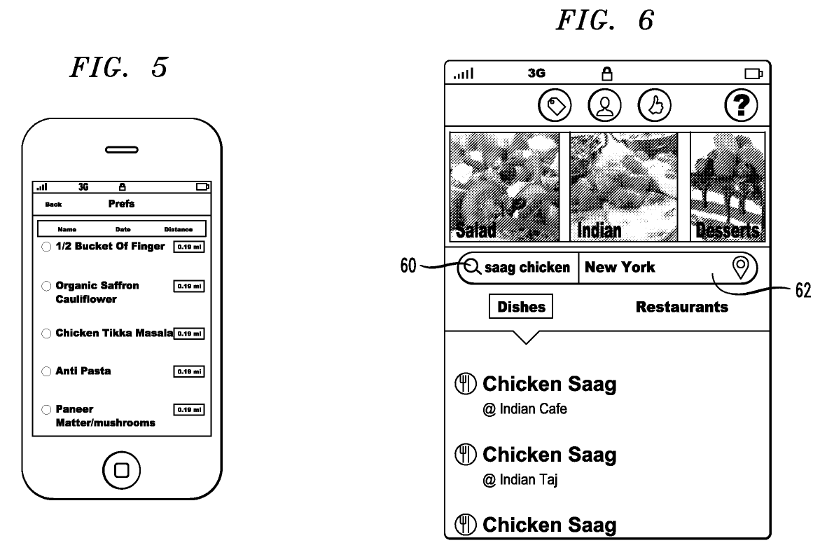

Suppose that user U lives in city A and has downloaded the myPref application into his mobile device 14. Among other items, user U has entered “chicken saag” as a “pref” for foods that he enjoys. At a later time, user U has traveled to city C and would like to find a restaurant that serves one or more of his “pref” foods. User U activates his myPref application and retrieves a listing of his “pref” foods (which is stored within his database record 22-U at platform 20). By launching the myPref application, user U sends a request through internet 12 to preference service platform 20, where special purpose computer 26 functions to verify the credentials of user U as a “registered” individual and then retrieve the food “pref” information from user record 22-U. This information is then communicated back to mobile device 14. FIG. 5 is a screenshot of this returned information, showing a set of “pref” foods associated with user U, as well as the “distance” to a location which serves this food (the distance determined by geo-location information within mobile device 14).

User U then selects a specific food on the listing, for example, “chicken saag”, where this information is then communicated through internet 12 to special purpose computer 26 at preference service platform 20. Special purpose computer 26 sends a query to merchant database 24 to search for restaurants in city C that serve this particular dish (where city C is selected based upon the current location of user U).

Special purpose computer 26 then creates a response in the form of a listing of all restaurants that serve this dish, and transmits the list through internet 12 back to mobile device 14 of user U. FIG. 6 is a screenshot of this step in the process, with the specific “pref” being searched located in window 60, and user's current location shown in window 62. As shown, the listing includes the name of each restaurant that serves this particular dish in this local geographic area. As an additional feature, this particular “page” of the preference-based shopping application includes a set of picture links 64 (shown as “salad”, “Indian” and “desserts”) that may be used to direct user U to other choices.

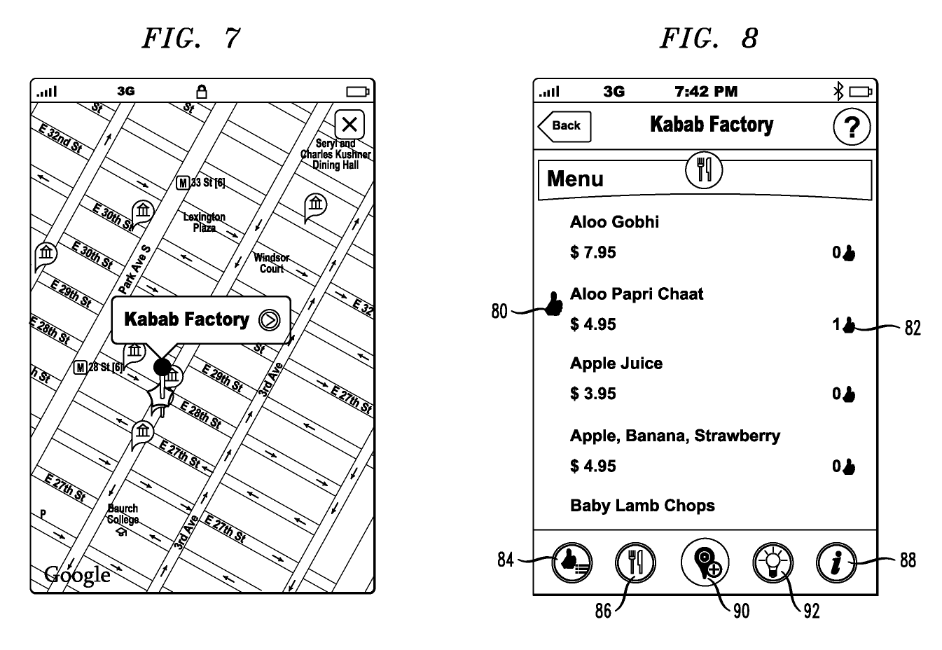

To assist in making a decision, user U can request a map showing the locations of the various restaurants, shown as a screenshot in FIG. 7, which indicates a restaurant that user U has included as a “pref” in database record 22-U.

Beyond providing this information, the user-defined preference shopping service of the present invention also allows for the user to view other information that a particular merchant (in this case, restaurant) may want a potential purchaser to review. In this case, the information takes the form of the “menu” of various dishes available at this restaurant. Moreover, as shown in the screenshot of FIG. 8, the service of the present invention is able to retrieve any other “pref” foods associated with user U that are also available at this restaurant. The “thumbs-up” icon 80 on the left-hand side of a specific dish indicates U's “pref” of this dish. Also shown in the screenshot of FIG. 8 is a “thumbs-up” icon 82 on the right-hand side of the display, associated with each dish in the listing. These icons are referrals (or “refs”) from individuals that are in the “retail shopping” network with user U. The numerical value of icon 32 indicates the number of U's associates that have sent him “refs” for this dish.

Various other icons that may be utilized to activate other options associated with the myPref service are shown in FIG. 8 as well. Icon 84 presents a new screen including a “listing” of all of user U's “prefs” that may be found at this restaurant. Icon 86 presents a new screen of all menu offerings for this restaurant, and icon 88 presents other “information” about the restaurant. The ability to “check in” (such as for a reservation) is provided by icon 90 and icon 92 provides a list of “deals” currently available.

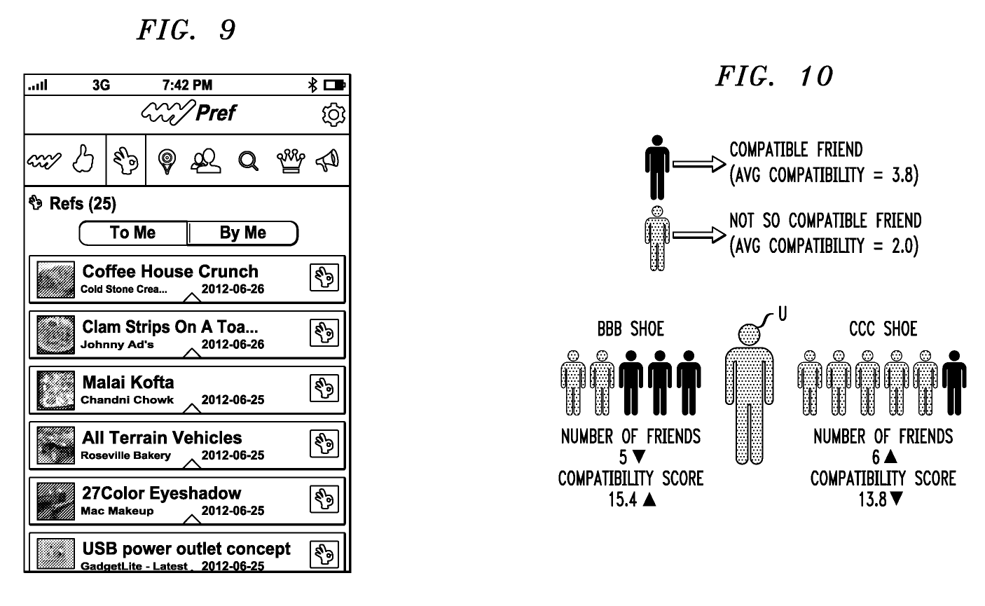

As mentioned above, one social networking aspect of the service of the present invention is the ability for individuals that are “connected” to each other in a self-defined “retail network” to send “refs” to others—where these referrals identify various products or services that an individual may think his friends would also enjoy. Unlike the random type of “target advertising” utilized by many vendors today, the ability to empower individual purchasers to share referrals with their friends and acquaintances improves the likelihood that the referral is actually considered by the recipient. FIG. 9 is a screen shot of an exemplary set of “refs” that are stored in database record 22-U for user U. As shown, these “refs” include foods and various other products.

Beyond merely identifying “refs”, the preference shopping service of the present invention is able to weight the importance of these recommendations to a specific user by providing a “compatibility index” (CI), generated by special purpose computer 26. FIG. 10 illustrates this concept. User U has received “refs” for running shoes from 11 different people in his retail network. Five of these friends have sent a “ref” for shoe BBB, and six friends have sent a “ref” for shoe CCC. Based on sheer numbers, therefore, user U would be more likely to purchase shoe CCC.

However, in accordance with the present invention, special purpose computer 26 is configured to perform an analysis to determine the number of instances where there have previously been preference matches between user U and this group of 11 people, defining in this case a “compatible” weighting factor (as well as a “not very compatible” weighting factor). As a results of this analysis, it is shown that a “compatible” friend has a weighting factor of 3.8, while the “not so” factor is a lower value of 2.0

In this particular example, the smaller group associated with shoe BBB is seen to include three friends with the higher “compatible” weighting factor, as compared with only a single friend having the “compatible” weighting factor that recommends shoe CCC. By determining the total “compatibility score” for each group (i.e., for BBB, 2*2+3*2.8=15.4 vs. for CCC 5*2+3.8=13.8), it is clear that user U's preference is more likely with the BBB shoe.

With all of this information as provided in accordance with this aspect of the present invention, therefore, user U will now be more likely to purchase shoe BBB and be pleased with this purchase.

While the ability to have the user/consumer be in control of the purchasing process by defining his own preferences, there are advantages to merchants as well. For example, one feature of the myPref service is defined as “check in” (shows as icon 40 on FIG. 8). This feature can be used in the conventional fashion as providing a message to a restaurant that an individual with a reservation has arrived. However, in the broader commercial context, this “check in” feature may be used (when activated by the individual) to announce his “arrival” at a merchant location that offers for sale one or more of his “pref” products (or, indeed, that specific retailer may be a “pref” itself). The local merchant location will receive a message from preference shopping platform 20 that user U has entered the store (where this message may also include information that user U often shops there for running shoes). Merchant M may then create special “deals” for user U and send them as messages to user U.

Inasmuch as these various preferences, purchases, referrals and the like are all stored and maintained in a database, a particular merchant may use this information as a mechanism to generate “rewards” for various individuals (for example, based on the number of “prefs” associated with that individual, or the number of “refs” that become “prefs” for other persons in that individual's network, or the like), Special purpose computer 26 may be particularly configured to analyze all of this data and determine different types of reward programs that are useful for the registered merchants.

As used herein, the terms “service platform”, “special purpose computer”, “databases”, “processor” and the like are all considered to assist in defining the concepts of the present invention in terms of presenting concrete realizations of a specific method—that is, assisting an individual in purchasing a particular product or service. The specific hardware components as embodied at the preferences service platform are required to store the “pref” and “ref” data, perform analysis of this data for a variety of applications (i.e., correlating user “prefs” with merchant products, analyzing the compatibility of various “refs” with a user's preferences, and the like). And while the term “special purpose computer” is used throughout the specification, it is to be understood that a general purpose computer may be provided with particular specialized programs and constructs to be transformed into a “special purpose” computer for the purposes of providing a preference-based shopping service platform.

While a number of exemplary aspects and embodiments have been discussed above, those of ordinary skill in the art will recognize certain modifications, permutations, additions and sub-combinations thereof. It is therefore intended that the following appended claims are interpreted to include all such variations within their true spirit and scope.

What is claimed is:

1. A network-based platform configured to enable user-defined, preference-based retail shopping, the platform including
a registered user database, the user database including a separate record for each user, the record including a listing of product/service preferences created and maintained by the registered user;
a registered merchant database, the merchant database including a separate record for each merchant that has subscribed to preference-based retail shopping service, including a link for communicating with an external database maintained by the registered merchant; and
a special-purpose computer in communication with the user database and the merchant database, the special-purpose computer including a microprocessor, memory and peripheral devices for analyzing, correlating and transmitting information regarding user preferences and merchant products and services, the special-purpose computer configured to interact via a communication network with mobile devices associated with each registered user, accepting modifications to the listings of preferences as transmitted by the users to the platform.

2. The network-based platform as defined in claim 1 wherein at least one record in the registered user database associated with a first registered user further comprises a listing of referrals sent from other networked users to the first registered user.

3. The network-based platform as defined in claim 1 wherein the special-purpose computer utilizes geo-location information from a registered user to provide a matching between a user preference and a registered merchant location offering the preference for sale.

4. The network-based platform as defined in claim 1 wherein a registered user performs an update to the associated database record by using a mobile communication device.

5. A method of performing user-defined preference-based retail shopping, the method comprising the steps of:
creating a database of user-defined product/service preferences, the database capable of being updated by registered users via associated mobile devices;
creating a database of registered merchants having retail locations in various cities, the database including a link for enabling communication with a merchant database;
receiving, at a special-purpose computer at a network platform, a request from a registered user for finding a pre-defined preference/product service;
determining, at the special-purpose computer, the current location of the registered user;
utilizing a processor within the special-purpose computer to search the registered merchant database based upon the requested preference/product and current location of the registered user; and
communicating the search results to the registered user to enable the registered user to review all results and continue with a retail purchase for a selected merchant.

6. The method as defined in claim 5 wherein the method further comprises the step of:
transmitting a product referral from a registered user's mobile device through the communication network to the network platform to other users as defined by the registered user, where the special-purpose computer recognizes the receipt of the referral, determines the identity of the other users and forwards the referrals to the proper records in the user database.

7. The method as defined in claim 5 wherein the special-purpose computer is further configured to generate a compatibility score between selected ones of networked registered users, the compatibility score based upon at least correlations between matching preferences of registered users.

8. The method as defined in claim 7 wherein the compatibility score further includes information related to determining the number of referrals that become preferences for a registered user.
